(19) United States
(12) Patent Application Publication
(10) Pub. No.: US 2010/0253077 A1
(43) Pub. Date: Oct. 7, 2010

(54) System for Connecting Undersea Pipes at Great Depths

(76) Inventor: Joseph Toupin, Sable Sur Sartre (FR)

Correspondence Address: THE WEBB LAW FIRM, P.C., 700 KOPPERS BUILDING, 436 SEVENTH AVENUE, PITTSBURGH, PA, 15219, US

(21) Appl. No.: 12/740,243

(22) PCT Filed: Nov. 5, 2008
(86) PCT No.: PCT/FR2008/051988

§ 371 Date: May 7, 2010

(30) Foreign Application Priority Data
Nov. 5, 2007 (FR) 0707773

(51) Int. Cl. F16L 13/14

(52) U.S. Cl. 285/382

(57) ABSTRACT

Disclosed is a connection system for connecting together at least two ends. The system includes a casing made of an elastic structure and a sleeve passing through the casing along its axis. The casing presents a thickness that is variable and defines a sealed volume such that pressure outside the sealed volume greater than the pressure inside the sealed volume causes the resilient structure to deform elastically so as to decrease the thickness of the casing to a thickness under maximum stress.

The present invention relates to a system for connecting undersea pipes, which system is specially designed for use at great depth.

Numerous means exist for assembling tubes together. Assembly may be performed by welding or by brazing, using threaded sleeves and couplings, or indeed movable flanges suitable for being secured to the ends of the tube segments for connecting together by rolling or expanding.

The feature common to all the above-listed connection techniques is the need to have available for performing them a system for delivering energy that may be in various forms:
heat energy or electrical energy (welding or brazing);
mechanical energy in order to be able to apply driving torque to nuts, screws, couplings, or sleeves, so as to deform them elastically, with said parts then storing the potential energy needed for clamping purposes.

Although this feature common to all of those joining systems presents no problems for sites in open air and on land, the same is not true for pipework installations in a medium where environmental conditions are extremely severe and present an insurmountable obstacle to direct human action. At great depth at sea, human action can take place only from a manned vehicle fitted with tooling of limited capability and of limited diving time, or else by means of a remotely-operated vehicle (ROV), for example.

In any event, it should be observed that connection systems used in air, i.e. on land, have been transposed in full to the undersea environment, even though it is an environment that is completely different. Deep water constitutes a hostile environment, given the magnitude of the pressure forces at great depth, but that pressure can be providential if used for one-off operations requiring a certain amount of work W, which work is given by the product of multiplying a force F by a travel distance L (W=F×L), where, given the magnitude of the forces likely to be used in the field of mechanics, that amount of work covers a vast range of potential applications: such as operations of clamping or puncturing thick metal sheets, for example, or operations of stressing elements that provide sealing, such as flanges and companion flanges for connecting pipes together, in particular.

It should be observed that the work used during those various operations may be deferred in time by being stored in an elastic system in the form of potential energy that can be made available at any instant merely by acting on a control member.

The object of the present invention is thus to provide a device and an associated method enabling at least two pipes to be connected together at great depth in sea water or the equivalent, which device and method are simpler to implement than the above-described devices and methods of the prior art.

This object is achieved by the fact that the connection device or system of the invention for connecting together at least two pipe ends comprises a casing made up of a resilient structure and a sleeve passing through the casing on its axis, said casing presenting thickness that is variable and defining a sealed volume, such that a pressure outside the sealed volume and greater than the pressure inside the sealed volume causes the resilient structure to deform elastically, tending to reduce the thickness of the casing to a maximally-stressed thickness. Furthermore, said connection system connects together said pipe by being placed between the two pipe ends and by equalizing the pressure inside the sealed volume with the pressure outside the sealed volume by means of a trigger member, such that the thickness of the casing is taken to a clamped connection thickness that lies between the unstressed thickness and the maximally-stressed thickness. The connection clamping is provided by the force that results from the elastic deformation of the casing exerted by the casing on the pipe ends. This enables large clamping forces to be implemented between the pipe ends and the connection system without it being necessary to a deliver a significant amount of energy (or power). The amount of power that needs to be delivered for triggering these forces is of the order of a few watts (or a few hundreds of watts).

The sleeve is an element of variable thickness serving to connect together and provide continuity between the inside volumes of the pipes for connecting together. The resilient structure is the outside portion of the casing and it co-operates with the sleeve to define the sealed volume. The inside portion of the casing is the sleeve.

The term “thickness” is used to designate the distance between the two free ends of the sleeve, i.e. the distance between the two ends that are to be connected to the pipes that are to be connected together.

It should also be understood that the connection system generates clamping forces adapted to connecting pipes together at great depth under water. These clamping forces are generally large. The trigger member serves to cause these forces to be applied. The trigger member itself is controlled by means that require little energy to be delivered. Thus, the application of the clamping forces is controlled by means requiring little energy, and power of a few watts suffices to trigger, or not trigger, actual connection between the pipes and clamping of the connection.

Advantageously, connection is established between companion flanges that are secured to the pipe ends for connecting together.

Preferably, the system also includes a bracket enabling the pipe ends for connecting together to be held in place.

Advantageously, the trigger member is a valve for establishing communication between the sealed volume and the outside environment, or for keeping them separate.

In a first variation, the connection system further includes a tank constituting a source of low pressure, making it possible, when in communication with the sealed volume, to bring the sealed volume to low pressure so as to unclamp the connection and allow the connection system to be dismantled by returning the thickness of the casing to its maximally-stressed thickness.

Preferably, the resilient structure is constituted by at least two resilient plates of frustoconical shape placed opposite-ways round and secured to each other via their large bases by screw-fasteners or welding, and via their small bases by the sleeve.

The term “large base” is used to mean the radial end of the plate that presents the greatest diameter, and the term “small base” is used to mean the radial end of the plate that presents the smallest diameter. In addition, the term “opposite-ways round” is used to mean that the large bases of the plates bear one against the other with each plate projecting from its large base away from the other plate, such that the small bases of the plates are situated on opposite sides of the plane defined by the contact zone between the large bases.

In a second variant, the resilient structure further includes additional springs.

Advantageously, the ends of the pipes for connecting together present counterbores against which bearing surfaces of the sleeve come to bear.

The term “bearing surface” of the sleeve is used to mean a zone or portion in relief of the sleeve that is designed to bear against the pipe ends. The term “counterbore” is used to mean a zone or portion in relief that is of a shape complementary to the shape of a bearing surfaces, such that the counterbore and the bearing surface fit each other and provide the connection between the sleeve of the connection system and the pipe.

Preferably, the bracket further includes sliding bushings.

In a third variant, the connection system enables to connect, with the help of the bracket, a pipe end with a sleeve that is fitted with a cap, thereby enabling the pipe end to be closed.

The invention also provides a method of connecting undersea pipes together, the method being characterized in that it makes combined use of two pressures, a surrounding “high pressure” of natural origin, and a “low pressure” provided artificially and contained in the system, with work driven by the above-mentioned pressure difference being stored in a resilient structure of deformable parts of the system, which parts are capable, when unopposed, of delivering all of the stored energy in the form of driving work, which partial or total delivery is remotely controlled by a trigger member eliminating the pressure difference by equalizing the internal and external pressures acting on said casing.

It can thus be understood that the method consists initially in putting a sealed volume defined by a casing (comprising a resilient structure) at a first pressure, e.g. ambient pressure at sea level. Thereafter, the method consists in taking the casing into a medium where the surrounding pressure is greater than the first pressure, e.g. the ambient pressure in sea water at a depth of two thousand meters (2000 m). Thus, the pressure inside the sealed volume defined by the casing is less than the pressure exerted by the outside medium on the casing, so the casing deforms. Naturally, to make such deformation possible, the sealed volume contains a compressible fluid, e.g. air. Once the casing has deformed, the pressure inside the sealed volume within the casing is taken to the ambient pressure outside the casing by means of a trigger member, e.g. a valve putting the sealed volume into communication with the outside medium. The pressures inside and outside the casing then tend to equalize, and as a consequence the casing tends to return to its initial shape. Naturally, the casing is designed in such a manner that the deformations to which it is subjected do not involve deformation in the plastic range, so as to ensure that the deformation of the casing is reversible.

During the stage of equalizing the internal and external pressures, the method consists in limiting or restricting return of the casing to its initial shape, e.g. by placing it between the two free but substantially stationary ends of the two pipes. Thus, when the casing tends to return to its initial shape, it bears against the free ends of the pipe and thus establishes the connection between the two pipes. Thereafter, when the pressures of the internal volume within the casing and the outside medium are in equilibrium, the casing exerts a clamping force that clamps (locks) the connection between the pipes and the casing. This clamping force is proportional to the elastic deformation to which the casing is constrained. In other words, when the casing is constrained, the greater the deformation of the casing, the greater the clamping force it delivers.

The general idea of this novel technology is to replace a connection making use of helical clamping, e.g. as represented by an assembly constituted by a screw and a nut, with a system that makes combined use of the surrounding hydrostatic pressure and the elastic properties of elements made of materials suitable, on being deformed, for storing potential energy. Such potential energy is referred to in static spring theory as the elastic potential or the internal potential of a said element. The element may be made of metal (e.g. steel) or of a natural or synthetic polymer (elastomer) or indeed out of a composite material (using glass, carbon, or aramid fibers), with it being possible to combine these various materials by means of a bonding matrix or a sandwich-type assembly.

The technique used for implementing the system of the invention thus makes use of hardware elements, some of which rely on elasticity and stiffness to absorb and deliver work, which hardware elements comprise an assembly referred to herein as a “casing B”, and others of which make use of the ability of hardware elements to oppose deformation and constitute an assembly referred to herein as a “bracket A”, which bracket opposes reaction forces to counter the drive forces developed by the casing B under certain conditions explained under the heading “operation of the system”.

Hydrostatics, or the statics of fluids, is well known, and thus the effect of gravity forces thereon is well known. A detailed description is not necessary. Although, as mentioned above, these forces give rise to a major obstacle to taking action in deep waters, they also provide potential energy characteristics that are considerable and advantageous. The present invention relies on two fundamental elements constituting the use of this property in association with the properties of springs.

In terms of energy, the basic theory is similar. For example, to obtain thermodynamic work, a cold source and a hot source are needed. Likewise, in the field of fluids, in hydraulics, e.g. two media are needed at different pressure levels in order to generate driving work. It can thus be understood that if the outside surface of a closed, rigid but resilient casing is subjected to a pressure that is greater than the pressure of a compressible fluid acting on its walls, a force arises that tends to flatten said casing, thereby modifying its dimensional characteristics. This deformation work corresponds to the potential energy that is stored by its structure and that can be returned in full or in part when the action of said source is eliminated.

It should be observed that when the casing is immersed within a liquid, this force changes all of the dimensions of its structure by compression, traction, or bending. These types of deformation have influences on the design of the casing that can be fully controlled by machining operations. For example, when seeking to make the action due to compression the preponderant action and to control said action it is possible to reduce the thickness of the structure of the casing in certain zones, thereby improving its flexibility, or on the contrary it is possible to increase its thickness in order to enhance stiffness. This stiffness limiting deformation may be enhanced by safety elements coming into contact once the reduction in the thickness of the casing has reached an optimum value.

Sites in deep water may be situated at different depths, and consequently the deformable casings B are adjusted on manufacture both as a function of the hydrostatic pressure that corresponds to the depth at which they are to be immersed, and as a function of the clamping force desired at the joint planes of the flanges, with adjustment being performed by appropriately dimensioning the surface area that is involved in the deformation. In addition, adapting the casing B to a particular purpose is directly linked with:

a) the materials selected for constituting its structure (flexibility, stiffness, modulus of elasticity, elastic limit); and

b) the thicknesses of the structure making up the walls of the casing B including zones of reduced strength as mentioned above or indeed zones of greater thickness enhancing stiffness of said zones.

For reasons of economy and simplifying fabrication, one determined type of structure for a casing designed for a particular depth of immersion may be adapted to a greater depth by providing it with adjustable additional loads, which additional loads may for example be constituted by springs of the conical spring washer type suitable for being mounted in columns or in bunches (these two methods of association may be combined with each other during assembly in a workshop).

To summarize:

As mentioned above, there are available:
a medium providing a source of high energy represented by the surrounding hydrostatic pressure;
a medium constituting a source of low energy represented by the internal volume of the casing B with air at low pressure (of the order of atmospheric pressure); and
a system suitable for storing or returning energy by making use of the properties of springs;
thus making it possible to obtain driving work or resisting work by using one or other of the above-mentioned sources and by keeping them separate or by putting them into communication by means of a “pressure-equalizing valve”.

A suitable combination of these means constitutes the basis on which the undersea pipe connection system of the invention operates.

The invention and its advantages can be better understood on reading the following detailed description of various embodiments given as non-limiting examples.

The description refers to the accompanying drawings, in which:

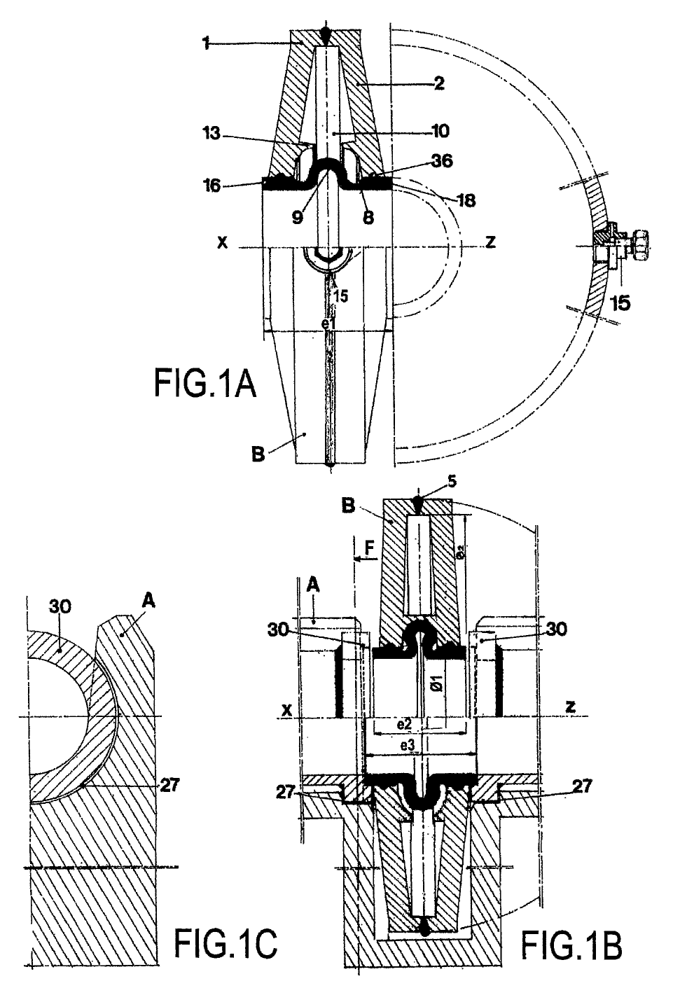

FIG. 1A is a fragmentary section view of a first embodiment of the invention at a thickness e₁, FIG. 1B comprises two half-sections at thicknesses e₂ and e₃, and FIG. 1C is a section on plane F of FIG. 1B;

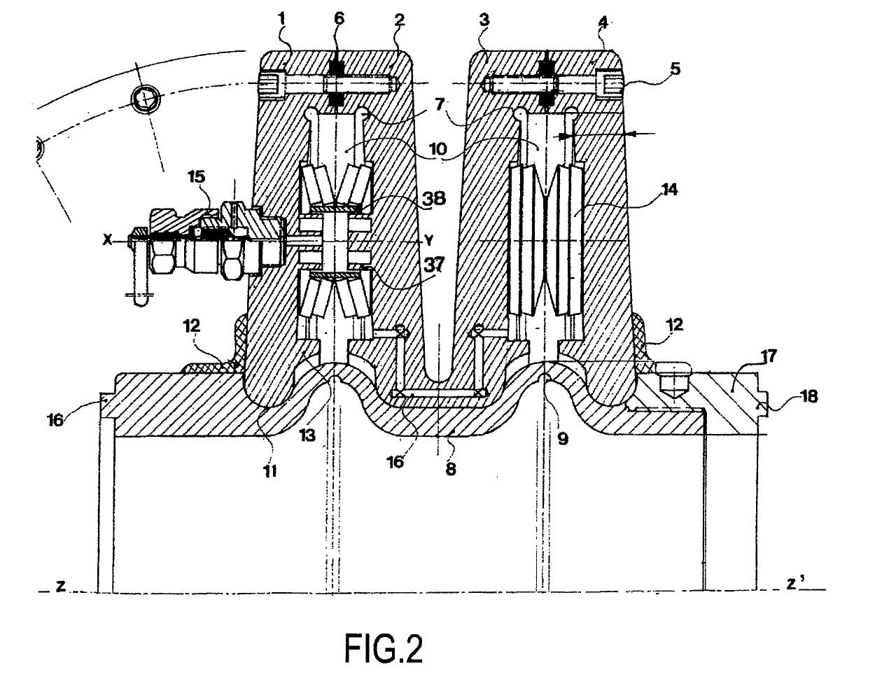

FIG. 2 is a half-section of a second embodiment of the invention;

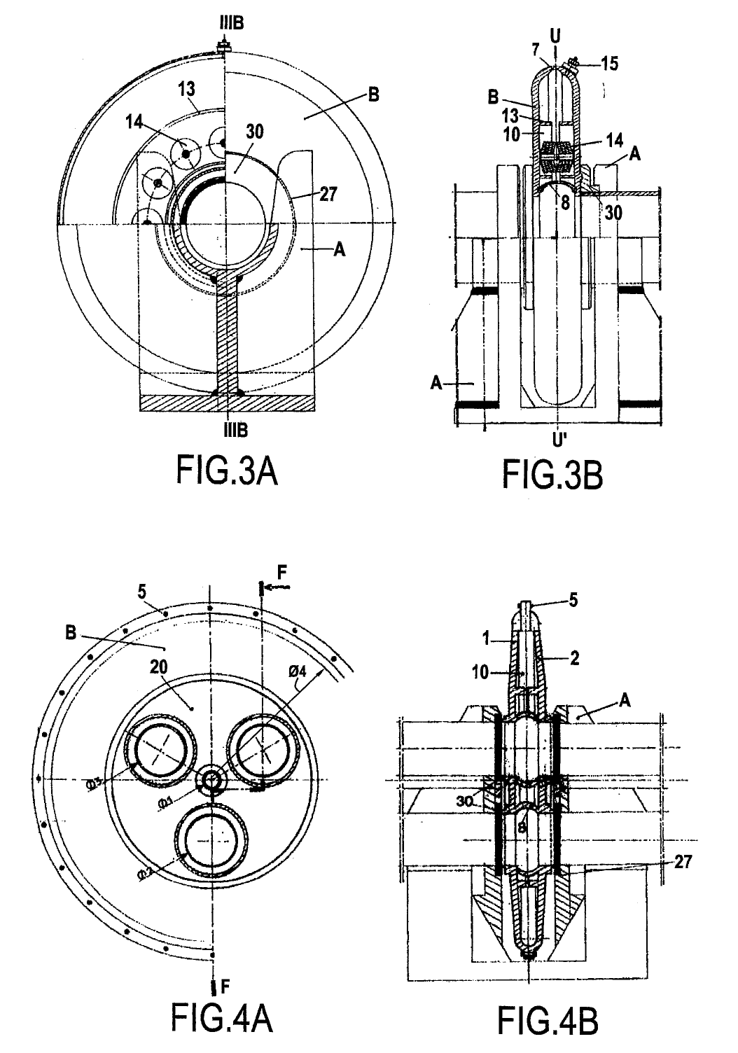

FIG. 3A is a face view, partially in section, of a third embodiment of the invention, and FIG. 3B is a view partially in section on plane IIIB of FIG. 3A;

FIG. 4A is a face view partially in section of a fourth embodiment of the invention, and FIG. 4B is a section view set back on plane FF of FIG. 4A;

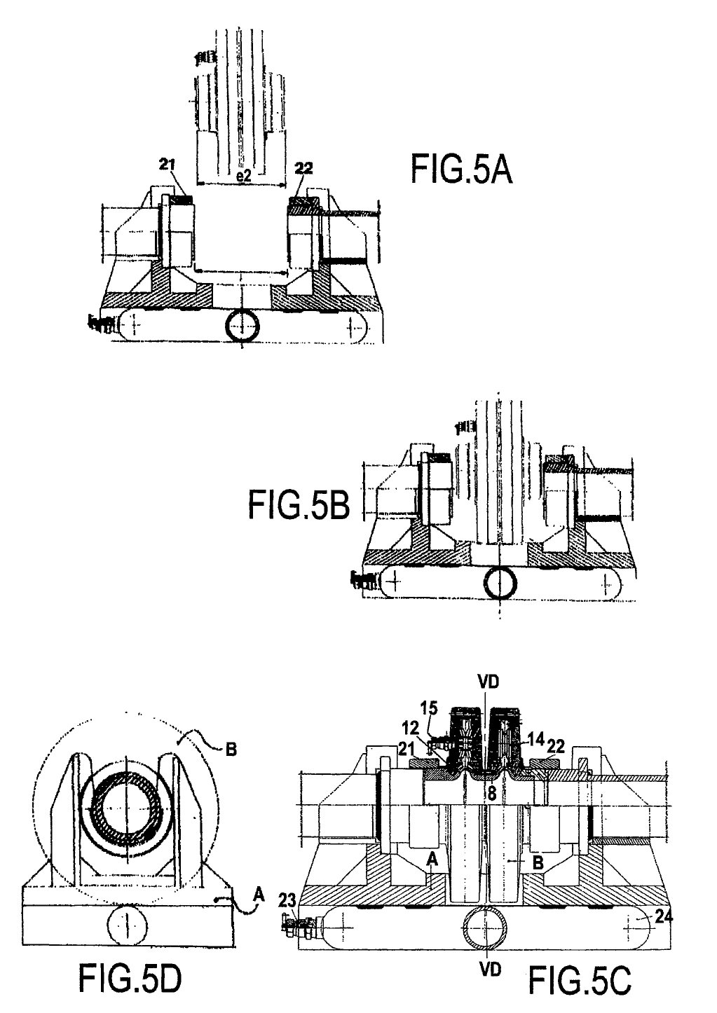

FIGS. 5A, 5B, and 5C show three stages in a method implemented in a fifth embodiment of the invention, FIG. 5D being a section on plane VD of FIG. 5C;

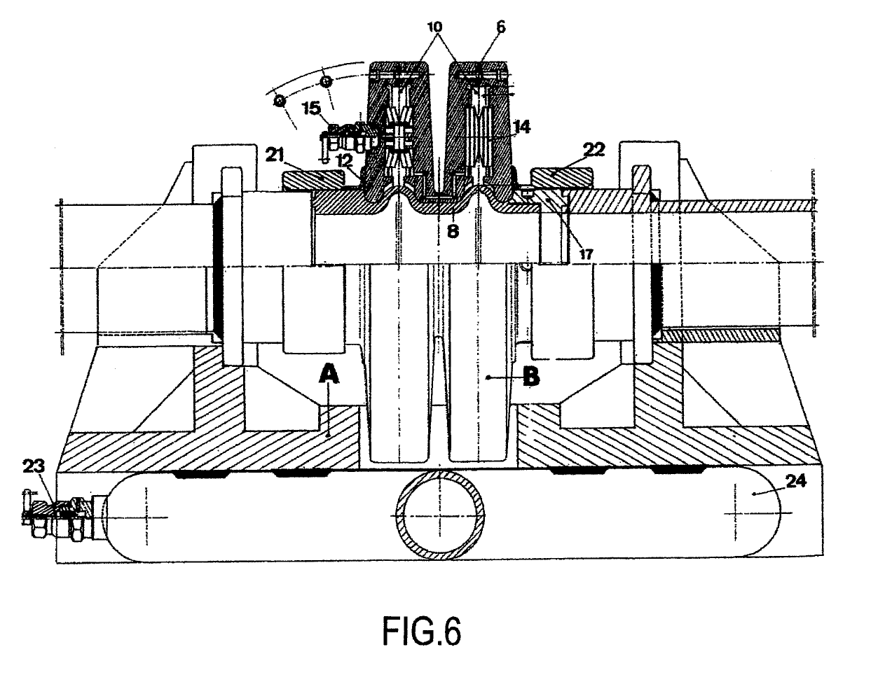

FIG. 6 is a fragmentary section of a fifth embodiment of the invention;

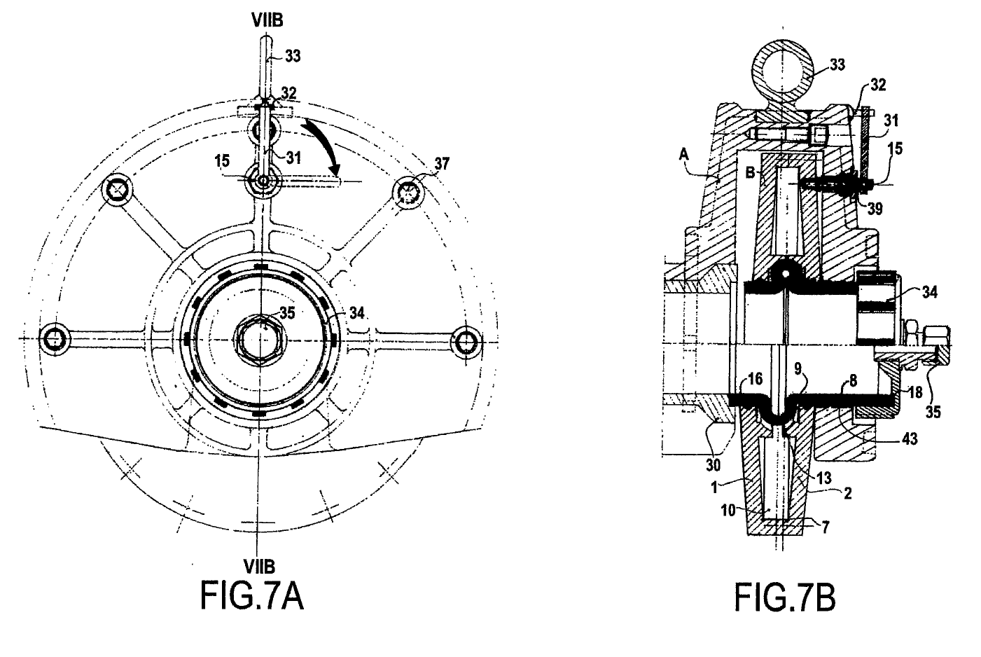

FIG. 7A is a fragmentary face view of a sixth embodiment of the invention, and FIG. 7B comprises two half-sections (at different thicknesses) of the FIG. 7A embodiment on plane VIIB;

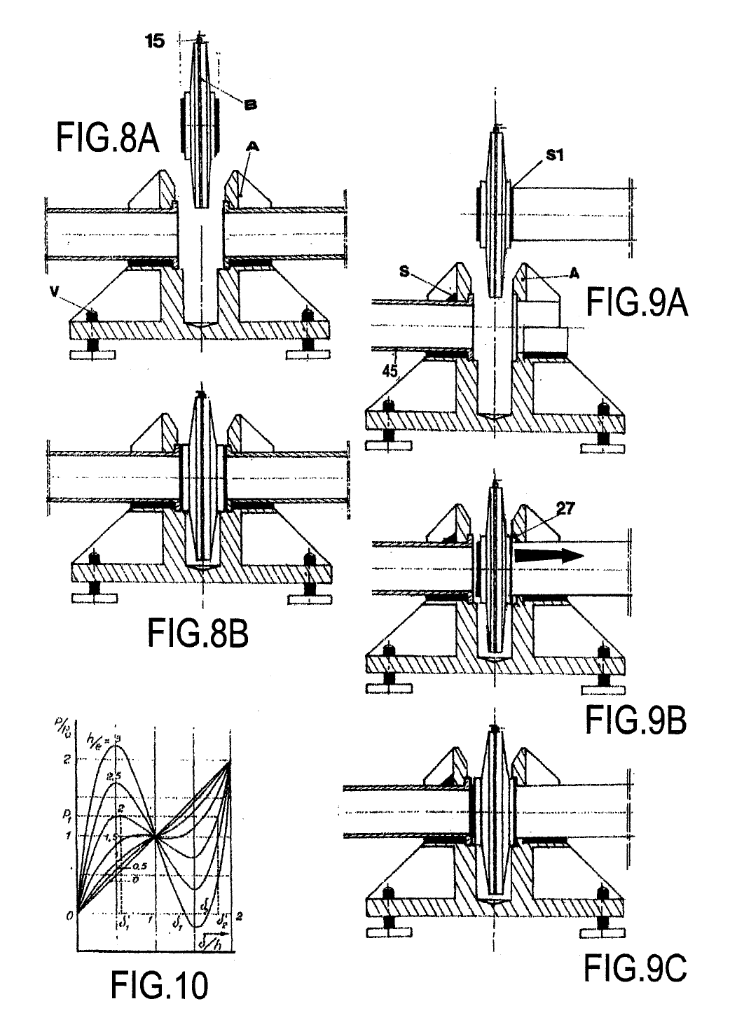

FIGS. 8A and 8B show two stages of a method of implementing the invention (respectively a valve-closed stage and a valve-open stage);

FIGS. 9A, 9B (valve closed), and 9C (valve open) show three stages in a variant of the method of implementing the invention;

FIG. 10 is a load/deformation diagram; and

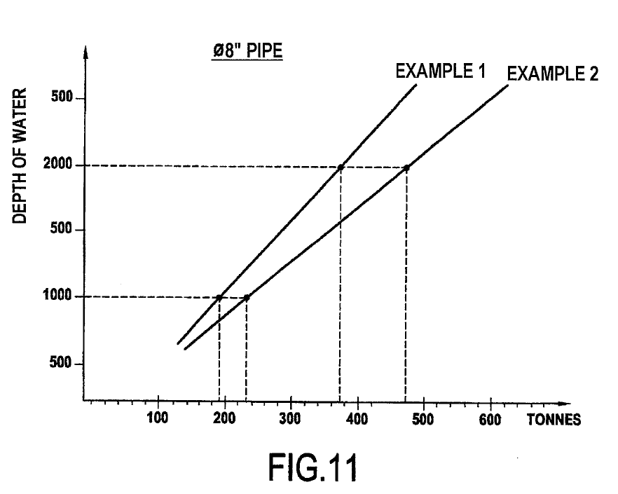

FIG. 11 is a diagram showing how loads vary as a function of the depth of water.

### FIGS. 1A, 1B, AND 10

The system of the invention comprises:
firstly a rigid casing B that is closed and constituted by two resilient plates 1 and 2 of frustoconical shape disposed opposite-ways round and secured to each other via their large bases by screw-fasteners or welding 5, and at their small bases by a sleeve 8. Said sleeve passes right through said casing B along its axis; at its center it possesses one or more folding annular portions that have previously been formed into a bellows 9 with circular portions 16 and 18 machined at the ends thereof perpendicularly to the axis XZ. It can thus be understood that the casing B comprising the sleeve 8 and the plates 1 and 2 is axisymmetric about the axis XZ, the sleeve 8 being mounted coaxially inside the plates 1 and 2. The plates 1 and 2 correspond to the resilient structure of the invention, i.e. the portion that generates the clamping force by elastic deformation. When the casing B is at rest, the distance between the two ends of the sleeve 8 is at a maximum and equal to e₁ (unstressed thickness). The sleeve 8, as fastened to the small bases 36 of the truncated cones by rolling or expansion, determines a leaktight volume 10 of annular shape that is suitable for being put into communication with the environment outside the casing by opening the valve 15 which is fastened to the large bases of the united plates that are secured to each other as mentioned above by screw-fastening the axis of the valve 15 perpendicularly relative to the axis XZ. It can thus be understood that the volume of annular shape is defined firstly by the sleeve 8 and secondly by the plates 1 and 2. In addition, it can also be understood that the sleeve 8 is elastically deformable, so the sleeve is suitable for storing energy by elastic deformation, and thus is suitable for contributing to the clamping force.

The inside portion of each frustoconical plate includes a circular projection 13 about the axis XZ formed therein by machining. Said projections are symmetrical to each other and face each other inside the annular volume 10. They make contact when the casing B is flattened to the maximum extent e₂. In other words, the projections 13 come into abutment against each other when the casing B is subjected to a pressure difference such that the casing B presents maximum deformation, i.e. deformation along the axis XZ, such that the distance between the two ends of the sleeve is at a minimum and equal to e₂ (thickness under maximum stress).
Furthermore, the system includes an all-welded bracket A constituted by a strength member of U-shape that deforms little and in which there are received two companion flanges 30 secured to the ends of the tubes for connecting together. These companion flanges are previously engaged in annular setbacks 27. The bracket A is suitable for holding the pipes via their companion flanges 30 to prevent them from moving apart from each other along the direction XZ. The bracket serves to take up the clamping forces generated by the casing B. In other words, when the casing B and the pipes are connected together, the bracket A holds the casing B via the companion flanges 30 in such a manner that the casing B generates a clamping force as a result of deforming elastically.

### Operation of the Coupling System of the Invention

FIGS. 1A, 1B, and 1C (first embodiment) show:
Firstly, at the top portion of the elevation and half-section view, the casing when free of any stress. The pressure inside the annular volume 10 is identical to that acting on the outside surface of the casing, and the valve 15 is closed. Under these conditions, the thickness of the casing B is at its maximum value e₁, corresponding to its non-immersed position.
Secondly, FIG. 1B shows the casing B in section when subjected to hydrostatic pressure (maximum stress thickness e₂), while FIG. 1A shows the non-stress thickness e₁, so the value of the maximum deformation is equal to e₁−e₂.
When subjected to hydrostatic pressure, the annular volume 10 is isolated from the outside medium by the valve 15, so said casing B of thickness e₁ takes up a thickness e₂, thereby enabling it to be inserted in the empty space determined by the surfaces of the facing companion flanges 30. The casing B flattens progressively while it is being lowered by the force developed by hydrostatic pressure and reaches its maximum deformation at this stage, which deformation is limited by the annular projections 13 coming into contact with each other and acting as a safety device.

The force determining this variation in thickness corresponding to flattening has a value given by the hydrostatic pressure per square centimeter (cm²) multiplied by the area corresponding to the outside diameter of the casing (Ø₂) minus the area corresponding to the inside diameter of the casing (Ø₁). The value of this area difference is of vital importance in the design of the casing and in adapting it to the working pressure of the fluid being transported, and more precisely to adjusting the elastic potential, i.e. the amount of work that can be stored by the casing B in question in the manner of a genuine spring system. With the casing B positioned as described above with its axis coinciding with the axis XZ (i.e. the casing B being positioned on the same axis as the pipes), the connection may be clamped by causing the valve 15 to open so as to equalize the pressures inside and outside said casing. As it expands, the casing forcibly engages the circular bearing surfaces 16 and 18 into the setbacks in the companion flanges 30. The companion flanges held in the circular setbacks 27 formed in the bracket A deliver an opposing reaction force corresponding to the magnitude of the clamping. In this position, the sleeve 8 of the casing B presents a distance between its ends (referred to as an intermediate distance) that is equal to e₃ (the thickness of the clamp connection), this thickness e₃ being less than the maximum thickness e₁ (casing B at rest) and greater than or equal to the minimum thickness e₂ (casing B at maximum deformation), i.e.: e₂≦e₃<e₁.

It should be observed that the operation of the system may theoretically be compared with spring washers of the Belleville type, where the relationship between the load P and the deflection Δ is not the same as with other types of spring. Such washers provide a load that is constant for a large variation in deflection, and they do so specifically in an operating zone that is particularly advantageous, i.e. close to maximum loading, and thus to maximum deformation (see the diagram of FIG. 10 on sheet 7/8). This feature has the consequence of a value for expansion that makes it possible, without significant loss of energy, to engage the circular bearing surfaces 16 and 18 deeply within the companion flanges 30.

FIG. 2 (second embodiment) operates identically to the first embodiment (FIGS. 1A, 1B, and 1C), and differs in that the casing B is constituted by four frustoconical plates 1, 2, 3, and 4 that are assembled together opposite-ways round in pairs and that are secured firstly via their large bases by screw-fasteners 5 bearing against annular gaskets 6, and secondly at their small bases by a sleeve 8 that is hydro- or thermo-formed prior to assembly and that presses against the round bases of the frustoconical plates 1 and 4. The sealing of the annular volume 10 relative to the outside is enhanced by two annular plastics drape-molded rings 12, one of them bearing against the sleeve 8 and the small base of the frustoconical plate 1, and the other bearing against the small base of the frustoconical plate 4 and the clamping nut 17. Clamping said nut tends simultaneously to lengthen the sleeve 8 and to urge the bases of the frustoconical plates thereagainst so as to establish a small amount of prestress in the assembly as mounted in this way. The two annular volumes 10 are put into communication, e.g. by a channel 16 or by a longitudinal slot machined in the sleeve 8 (not shown).

As described with reference to FIGS. 1A and 1B, there are annular projections 13 that limit deformation when they come into contact. In this position, these projections receive the bellows 9 that come to bear against them.

On the axis XY and on a circle concentric about the longitudinal axis of the sleeve 8, there are located additional loads 14 in the form of conical spring-washer type springs, as mentioned above, which spring washers have pins 37 passing therethrough and engaging their small bases via sliding bushings 38 that are distributed symmetrically on a circle concentric about the axis Z-Z′, the pins being angularly spaced apart by an amount that is determined during assembly in a workshop. The set of additional removable and adjustable loads makes it easy with the system of the invention to adapt a structure based on the casing B to different depths of water, and thus make it suitable for use on sites at different depths.

The frustoconical plate 1 has the equalizing valve 15 screwed into the side thereof to isolate the annular volumes 10 from the outside environment (when closed) or on the contrary to put those two media into communication (when open). This member serves to allow or prevent the annular volumes 10 to be put into equilibrium with the surrounding pressure, and it may be of the needle valve type or of the electrically controlled valve type with low-power ultrasonic control that can be operated remotely from an ROV or indeed from a ship on the surface.

The main advantages of the above-described variant of the connection system lies firstly in the increase in the magnitude of the deflection, which is multiplied by two for the same load, and secondly in the possibility of increasing said load to a desired value by means of spring washer type springs 14. In this embodiment, the resilient structure corresponds to four plates 1, 2, 3, and 4 in combination with the additional loads 14. Naturally, it is also possible to fit such additional loads or springs 14 to the first embodiment (FIGS. 1A and 1B).

FIGS. 3A and 3B (third embodiment) show a casing of a shape that is slightly different from the biconical shape shown in FIG. 1A, and in which a groove 7 is formed at the periphery of the annular volume 10 for the purpose of orienting the deformation of said casing, the neutral fiber being situated on the axis UU'. FIG. 3A shows the positioning of additional loads 14 located on a circle concentric with the axis of the lengths of pipe for connecting together, the circular projections 13, and finally the circular setbacks 27 for engaging the companion flanges 30 in the bracket A.

FIGS. 4A and 4B (fourth embodiment) show another variant enabling the system of the invention to connect together simultaneously a plurality of pipes of diameters Ø1, Ø2, Ø3, and Ø4.

The frustoconical plates 1 and 2 are used again, which plates are secured to each other via their large bases by screw-fasteners or welding 5 and via their small bases by the sleeve 8 that is welded to a thicker plate 20 that deforms little and that is driven during deformation of the plates 1 and 2 under the effect of hydrostatic pressure to move in translation so as to reduce the thickness of the casing or so as to allow it to expand when the pressures are equalized. The annular space 10 has the same functions as in the embodiments described above (equalizing valve not shown). The annular setbacks 27 receive the companion flanges 30 in the bracket A.

FIGS. 5A, 5B, 5C, and 5D show the stages of mounting the casing B in the bracket A like a guillotine blade, i.e. mounting the casing B between two ends of pipes held by the bracket A (the casing B is that of a fifth embodiment that is described below with reference to FIG. 6). The stages one (FIG. 5A) and two (FIG. 5B) show the casing B being lowered so as to be subjected, on reaching the bottom, to the maximum hydrostatic pressure that changes its thickness to the value e₂, thereby enabling said casing to be inserted into the space between the two companion flanges 30 that are facing each other (stage two).

Stage three (FIGS. 5C and 5D) correspond to the casing expanding elastically and to the connection system being clamped by opening the valve 15 that equalizes the pressures inside and outside the casing B.

It should be observed that in stages one and two, the slidable bushings 21 and 22 are in a retracted position and they provide overlap after clamping in stage three (this variant is explained with reference to FIG. 6).

FIG. 6 (fifth embodiment) presents the system of the invention for connecting together two pipe segments positioned in the bracket A. The stiffness of the connection is thus enhanced by the sliding bushing 21 that covers the end of the sleeve 8 and the sliding bushing 22 that covers the nut 17 and prevents it from turning.

A tank 24 that withstands the highest hydrostatic pressures is secured to the bracket A by welding, and constitutes a source of low pressure energy needed for dismantling the connection system of the invention. Unclamping and dismantling by returning to the initial pressure conditions prior to clamping, are achieved by putting the tank 24 into communication with the annular volumes 10 when the valve 23 is open. It becomes possible to decouple the bracket A from the casing B only after the bushings 21 and 22 have slid back into their initial positions prior to overlapping.

This dismantling device incorporating a source of low pressure in the bracket-and-casing assembly advantageously limits the action taken (e.g. by an ROV) to using pipework to interconnect the valves 23 and 15 that are positioned in such a manner as to isolate the annular volumes 10 from the surrounding pressure and to subject said annular volumes to the low pressure source constituted by said tank 24.

The capacity of the tank 24 should not be less than the total of the volumes represented by the annular volume(s) 10 and by the connection pipework.

It is advantageous to adopt this system for joining together underwater pipes that are capable of presenting segments of great length as is made possible by the low specific weight of said segments (next use of flexible risers). It should be observed that the tank 24 enhances the stiffness of the bracket A with which it forms a unit assembly.

FIGS. 7A and 7B (sixth embodiment) show a variant operating on the same principles as the system of the invention and specially designed for closing the ends of segments of undersea pipe during dismantling operations, when the pipes are full of polluting substances such as liquid hydrocarbons (e.g. after an oil field has been abandoned).

One difference compared with the above-described variant lies in the fact that the bracket A is secured to the casing B by means of the deformable sleeve 8 that is threaded at 43. After being lowered, the unit assembly designed in this way covers and holds captive the companion flange 30, as can be seen in the section view (top half) of the casing and the bracket showing them in their position prior to clamping; and as can be seen in the section view (bottom half) showing the sealing provided, after clamping, by the bearing surface 16 bearing against the circular counterbore of the companion flange 30.

FIGS. 7A and 7B show a lifting ring 33, and a screw cap 34 that, on being unscrewed, enables the segment of pipe to be emptied when said segment reaches the surface, while the other end (not shown, but provided with the same assembly) enables a surfactant or steam under pressure to be injected via the threaded connection 35 for the purpose of fluidizing the remainder of the substance that is contained in the pipework, and thus enables it to be recovered.

The other difference lies in the equalizing member 15 referred to as a valve in the above embodiment, which is replaced by a breakable tube 39 suitable for equalizing the pressure in the annular volume 10 with the surrounding hydrostatic pressure by turning a lever 31 through one-fourth of a turn for the purpose of twisting and then breaking the breakable tube 39 that is held at one end by tapping in the wall of the frustoconical plate 2 and that is closed at its other end. In order to avoid untimely operation of the command for equalizing pressure inside the casing B with environmental pressure during handling and lowering on site, a fork-shaped part 32 with a lead seal serves to prevent the lever 31 from moving.

At the end of the operation of emptying the segment of pipework, the companion flanges 30 are released from engagement in the brackets A by unscrewing the assembly screws 37.

FIGS. 8A and 8B (valve open, valve closed) show on-site assembly of the connection system of the invention. The casing B is positioned in the bracket A like a guillotine blade, in a process that is identical to that described with reference to FIGS. 5A, 5B, 5C, and 5D.

FIGS. 9A and 9B (valve closed) and 9C (valve open) show a variant assembly of the connection system of the invention. This variant consists in securing the bracket A to the end 45 of the tube for connection by welding S prior to lowering them, and in placing the assembly on the bottom, while the casing B is itself secured by welding S₁ prior to being lowered with the other end of the tube for connection and is then lowered and engaged in the annular setback 27. Said casing is then in the position corresponding to clamping the connection system of the invention.

FIG. 11 is a graph showing how loads vary as a function of the differences in area that are adopted. In the example below, the connection system of the invention is fitted to a pipe having a nominal diameter Ø equal to 8 inches, i.e. 203.2 mm (1 inch=25.4 millimeters). Load in (metric) tonnes is plotted along the abscissa and the depth of water corresponding to the undersea site is plotted up the ordinate.

Example No. 1 (depth of water 2000 meters (m) and a coefficient K=Ø2/Ø1=600/350=1.714) corresponds to stress at the plane of the joint equal to 373 tonnes.

Example No. 2 (same depth of water and a coefficient K=Ø2/Ø1=650/350=1.857) corresponds to stress at the plane of the joint of 471 tonnes. The power enabling these forces to be triggered by remote control is a few watts (W).

### NOTATION

### (Definitions) see FIGS. 1A and 1B

e₁ thickness of the unstressed casing
e₂ thickness of the casing under maximum stress
e₃ thickness of the casing with the connection system clamped
Ø₁ diameter of the area not involved in deformation of the casing
Ø₂ diameter of the ring contributing to deformation of the casing
SØ₂-SØ₁ differential surface area involved in the deformation

### Loads as a Function of the Differential Surface Area Involved

### Example 1

nominal pipe Ø 8 inches, depth of water 2000 meters
Ø₂=600 mm S=2826 cm²
area difference: 2826−961=1865 cm²
   Ø₁=350 mm S=961 cm²
   Total load at 2000 meters: 200×1865=373,000 kilograms (kg)
   Area of joint 66 cm²
   pressure on the joint: 373,000÷66=5651 kg/cm²

### Example 2

nominal pipe Ø 8 inches
Ø₂=650 mm S=3316 cm²
area difference: 3316−961=2355 cm²
   Ø₁=350 mm S=961 cm²
   Total load at 2000 meters: 200×2355=471,000 kg
   Area of joint 66 cm²
   pressure on the joint: 471,000÷66=7136 kg/cm²

1-11. (canceled)

12. A connection system for connecting together at least two pipe ends, the system comprising a casing made up of an elastic structure and a sleeve passing right through the casing along its axis, said casing presenting a thickness that is variable and defining a sealed volume such that pressure outside the sealed volume greater than the pressure inside the sealed volume causes the resilient structure to deform elastically so as to decrease the thickness of the casing to a thickness under maximum stress, and wherein said connection system connects said pipe by being disposed between the two pipe ends and by equalizing the pressure inside the sealed volume with the pressure outside the sealed volume by means of a trigger member so that the thickness of the casing changes to a clamped connection thickness lying between the unstressed thickness and the thickness under maximum stress, the connection clamping being provided by the force that results from the elastic deformation of the casing exerted by the casing on the pipe ends, thereby enabling high clamping forces to be implemented between the pipe ends and the connection system without providing a significant amount of energy.

13. The connection system according to claim 12, wherein the connection is performed between companion flanges secured to the ends of the pipes for connecting together.

14. The connection system according to claim 12, wherein the system further comprises a bracket enabling the ends of the pipes for connecting together to be held relative to each other.

15. The connection system according to claim 12, wherein the trigger member is a valve enabling the sealed volume to be put into communication with or separated from the outside environment.

16. The connection system according to claim 12, further including a tank constituting a source of low pressure, making it possible, on being put into communication with the sealed volume, to return the sealed volume to low pressure so as to unclamp the connection and allow the connection system to be dismantled by bringing the thickness of the casing to its thickness under maximum stress.

17. The connection system according to claim 12, wherein the resilient structure is constituted by at least two resilient plates of frustoconical shape placed opposite-ways round and secured via their large bases by screw-fasteners or welding, and via their small bases by the sleeve.

18. The connection system according to claim 12, wherein the resilient structure further includes additional springs.

19. The connection system according to claim 12, wherein the pipe ends for connecting together presents counterbores in which bearing surfaces of the sleeve come to bear.

20. The connection system according to claim 14, wherein the bracket further includes sliding bushings.

21. The connection system according to claim 14, wherein the system enables to connect, with the help of the bracket, a pipe with the sleeve fitted with a cap for closing said pipe end.

22. A method of connecting undersea pipes together, the method making combined use of two pressures, a surrounding external “high pressure” of natural origin, and an internal “low pressure” provided artificially and contained in the system, with work driven by the difference between these pressures being stored in a resilient structure of deformable parts of the system, which parts are capable, when unopposed, of delivering all of the stored energy in the form of driving work, which partial or total delivery is remotely controlled by a trigger member eliminating the pressure difference by equalizing the internal and external pressures acting on said casing.
